(19) United States
(12) Patent Application Publication
(10) Pub. No.: US 2010/0211611 A1
(43) Pub. Date: Aug. 19, 2010

(54) Method and an apparatus for detecting and evolving of a structure for storage, analysis, and exchange of information data between domains and organizations

(76) Inventors: Stefan Horn, Erlangen (DE); Rupert Maier, Eggolscheim (DE)

Correspondence Address: HARNESS, DICKEY & PIERCE, P.L.C., P.O.BOX 8910, RESTON, VA, 20195, US

(21) Appl. No.: 12/385,039

(22) Filed: Mar. 30, 2009

(30) Foreign Application Priority Data
Feb. 19, 2009 (EP) EP09002371

(51) Int. Cl. G06F 7/00; G06F 17/30

(52) U.S. Cl. 707/803; 707/E17.012; 707/E17.044

(57) ABSTRACT

A method and an apparatus are disclosed for detecting and evolving of a structure for storage, analysis and exchange of information data between domains and organizations. In at least one embodiment, the schema of all relevant domains of the organizations is determined on the basis of the meta-schema which includes a set of rules for generating the schema which has at least one dimension. Data of one domain can be easily used for evaluation or decision taken in other domains within the same or different organizations.

### PRIORITY STATEMENT

The present application hereby claims priority under 35 U.S.C. §119 on European patent application number EP09002371 filed Feb. 19, 2009, the entire contents of which is hereby incorporated herein by reference.

### FIELD

At least one embodiment of the present invention generally refers to a method and/or an apparatus for detecting and evolving of a structure for storage, analysis and exchange of information data between several domains within organizations. In particular, at least one embodiment of the present invention refers to a method for detecting and evolving of the structure, a computer product configured to implement the method, a data carrier comprising the computer product, and/or an apparatus configured for detecting and evolving of the structure of information exchanged between domains within organizations.

### BACKGROUND

A structure of a company, concern, or in general of organizations comprises several areas, i.e., several domains (e.g., production, research, management, etc.), wherein each of the domains can use its own vocabulary or terms for characterizing and structuring of the domain. Further, also even if the terms used in several domains are similar or the same, the meaning of these terms can often be domain specific and vary.

Further, the domains of organizations can overlap with regard to their functionalities and with regard to their respective structure. If several terms are used for the same items and/or if several and domain specific interpretations for the same terms are possible, the communication between the domains of the organizations, which use these terms when communicating with each other, becomes difficult and erroneous.

In particular, the following problems can arise with regard to storage, analysis and exchange of information data between several domains of organizations:

Unclarity of information; the reason for this unclarity can be, for example, a lack of quality of information exchanged and a possible misunderstanding with regard to used terms or matters. Consequences of such an unclarity of information can be increased complexity, expenditure, and/or costs of communication within the organizations, since many clarifying communications are required; as well as hindered and complicated building of knowledge in the organizations, as a lot of additional and clarifying information is necessary to dissolve the arisen unclarities.

As an example for such an unclarity of information, clarifying of the following question can be taken: “How much does the development require?” A product management domain will interpret this question as follows: “How much does the development of new products require?” A personal management domain, in turn, will understand this question in the following manner: “Which costs arise by employing of corresponding developers?” Thus, a simple question concerning costs of development can be a reason for a hindered communication between two departments or domains of the same organization.

Incomparableness of information; here, within several domains it is assumed that the same items, matters, and objects with the same meanings are discussed between these domains; however, actually within each domain its own interpretation of items, matters, and objects is considered.

Thus, for example, two different departments of an organization can have a discussion with regard to new products. The first department refers to a first version of a product, whereas second department, in turn, refers to another version of the product (being, e.g., in development).

Here, the consequences are developments of different strategies, analysis etc., which can not be fed together and which lead to erroneous trends or developments in the organization.

In all of the above cases, additional labour and costs arise within the organization because no consistent communication between the several domains does exist and a plurality of developments are performed, which can not be fed together at the end. A further reason can be that the communication between the domains is difficult and not transparent, so that wrong decisions are made etc. due to the unclarity and/or incomparableness of information exchanged between organizations and between different domains.

Furthermore, unclarities and incomparableness of information exchanged within an organization or between organizations often remain hidden or are not detected fast enough. Thus, additional costs can arise for longer periods of time. Further, the structure of an organization itself can become inflexible and inefficient because of ineffective and erroneous communication between different domains of the same or different organizations.

### SUMMARY

In at least one embodiment of the present invention, a method is provided by use of which unclarity and incomparableness of information stored, analyzed or exchanged between domains of organizations is minimized or even completely avoided.

In at least one embodiment of the present invention, a method is disclosed for detecting and evolving of a structure of information stored, analyzed and exchanged within or between domains within organizations, said method comprising determining of a schema of all relevant domains of said organizations on the basis of a meta-schema.

The meta-schema comprises, in at least one embodiment, a set of rules for generating a schema for selected domains of organizations.

In a possible embodiment a rule of that meta-schema requests that dimensions, i.e. term dimensions, of said schema are orthogonal to each other (orthogonality rule).

A further rule of that meta-schema is that each dimension, i.e. each term dimension, comprises a hierarchy of nodes, wherein to each node a sub-term belonging to said term of the respective dimension is assigned, i.e. each dimension comprises a hierarchy of nodes or terms (hierarchy rule).

A further rule of the meta-schema is autology of each dimension, i.e. a dimension is self-explaining by the terms or nodes of the respective dimension (autology rule).

Another rule of the meta-schema is modularity, i.e. the hierarchy of nodes or terms belonging to a dimension can be decomposed consistently allowing to address nodes of said dimension individually (modularity rule).

In this way, a transparent representation of information, topics, workflows, processes, and/or matters of domains of an organization becomes possible, wherein unclarities and incomparableness of terms used within and between the domains are avoided in an efficient and effective way. By use of the method of the present invention, a compact and structured representation of information, topics, workflows, processes, and/or objects of domains is possible. The method is easy to use and allows a clear view to processes, concepts, and relationships of domains of organizations.

Further, an effective and efficient representation of information, topics, workflows, processes, matters or objects of domains is enabled, which allows saving of computing resources provided to store the information, topics, workflows, processes, and/or matters of domains. Moreover, the structuring of the information, topics, workflows, processes, and/or matters of domains can be performed efficiently by corresponding computing resources. Thus, a fast operating of the corresponding computing resources used for performing the method of present invention in a corresponding apparatus or system can be achieved by the method of at least one embodiment of the present invention.

According to an embodiment of the present invention, the at least one dimension represents a topic of said domain and the nodes of said hierarchy of nodes represent terms of said topic of said domain.

In this way, at least one embodiment of the present invention enables a clear partitioning of information, items, and matters, which provides a clear and transparent overview of domains of organizations.

According to an embodiment of the method according to the present invention, nodes of one level of said hierarchy of nodes represent comparable nodes in said hierarchy of nodes. Here, the term “comparable nodes” refers to nodes which represent comparable terms, i.e., terms, which refer to the same degree of abstraction of terms, between which (functional) relations are or can be established.

According to a further embodiment of the method according to the present invention, each of the nodes of said hierarchy of nodes comprises at least one of following:

a description of the respective node;

a denotation of the respective node;

a list of synonyms for said denotation of the respective node; and

a structure information specifying the nodes placed in levels below the level in said hierarchy, at which the respective node is provided.

Further, according to an embodiment of the method of the present invention, the method comprises an evaluating of said schema of said domain. Thus, the generated schema can be verified.

According to an embodiment of the method of the present invention, the method comprises a re-determining of said schema of said domain if said evaluating indicates that further aspects of said domain have to be covered by said schema of said domain.

In this way, further improvements and changes with regard to structure, information, and matters of a domain can be handled and taken into consideration. The generated or determined schema does not represent a fixed schema, i.e. the schema can be adapted to further developments within domains. If further developments within one or several domains occur, the schema is established such that only adding of new nodes or a removal of existing nodes, which are not up-to-date, is performed. According to at least one embodiment of the present invention, a flexible arranging of the schema is enabled, wherein it is always ensured that the provided schema is directed to the current situation and state of the respective domains, which are specified by the schema.

In at least one embodiment of the present invention, a computer program product is disclosed comprising a code, the code being configured to implement and/or to perform the method of at least one embodiment introduced above and explained in more detail below.

According to an embodiment of the present invention, the code is embodied or stored on a data carrier. According to a further embodiment of the present invention, the computer program product is configured to perform said method when the computer program product is executed by a processing unit like a processor.

In at least one embodiment of the present invention, a data carrier is disclosed comprising said computer program product.

Moreover, in at least one embodiment of the present invention an apparatus is disclosed, said apparatus being configured for detecting a structure of information stored, analyzed or exchanged within several domains of organizations, said apparatus comprising:

a schema generating module, said schema generating module being provided to determine said schema of said domains within organizations by use of a predetermined meta-schema, said meta-schema comprising a set of rules to identify and define a structure of a schema of domains and organizations.

In an embodiment of said apparatus the meta-schema is stored in a database and comprises:

an orthogonality rule,

an autology rule,

a hierarchy rule and

a modularity rule.

Thus, at least one embodiment of the present invention enables a flexible and efficient way of handling of information and objects of domains of organizations in a transparent and measurable way. By use of at least one embodiment of the present invention, unclarities and incomparableness with regard to information, terms, and objects of domains of organizations are avoided and overcome.

Further, by use of at least one embodiment of the present invention management and control processes of organizations can be improved significantly. At least one embodiment of the present invention enables a targeted and focused adapting and filtering of information or data, topics, workflows, processes, and/or objects by use of several criteria from several points of view (e.g., coverage of business, customer profiling, product portfolios etc.).

Moreover, the method of at least one embodiment of the present invention allows an integration of further developments and further matters or objects into an already generated schema. Thus, at least one embodiment of the present invention always presents current views on one or several organizations, in particular, to its structure, topics, processes, matters etc.

Furthermore, an effective and efficient representation of information, topics, workflows, processes, and/or matters of domains is enabled by the method of at least one embodiment of the present invention, which enables saving of computing resources provided to store the information, data, topics, workflows, processes, and/or matters of domains. Moreover, a fast and efficient performing of analysis, processing, and/or handling of data structured is enabled. Thus, a fast operation of the corresponding computing resources used for performing the method of at least one embodiment of the present invention in a corresponding apparatus or system is achieved.

### BRIEF DESCRIPTION OF THE DRAWINGS

The present invention will be understood more clearly from the following description of embodiments of the invention read in conjunction with the attached drawings, in which:

FIG. 1 shows an apparatus configured for detecting of a structure of information stored, analyzed or exchanged between several domains of organizations according to an embodiment of the present invention;

FIG. 2 shows steps of a method for detecting of a structure of information stored, analyzed or exchanged between several domains of organizations according to an embodiment of the present invention; and

FIG. 3 shows a meta-schema used for detecting of a structure of information according to an embodiment of the present invention.

### DETAILED DESCRIPTION OF THE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

The following embodiments of the present invention describe a method, an apparatus, and a schema for detecting of structure of information stored, analyzed or exchanged within several domains of an organization. According to an aspect of an embodiment of the present invention, dimensions can be used for collecting, exchanging, and/or for analysis of several facts and objects in several domains and areas of the operative business of one or several organizations. A meta-schema which specifies requirements and rules for a schematic representation of objects (e.g., processes, terms, topics) of domains of at least one organization is used according to the present invention.

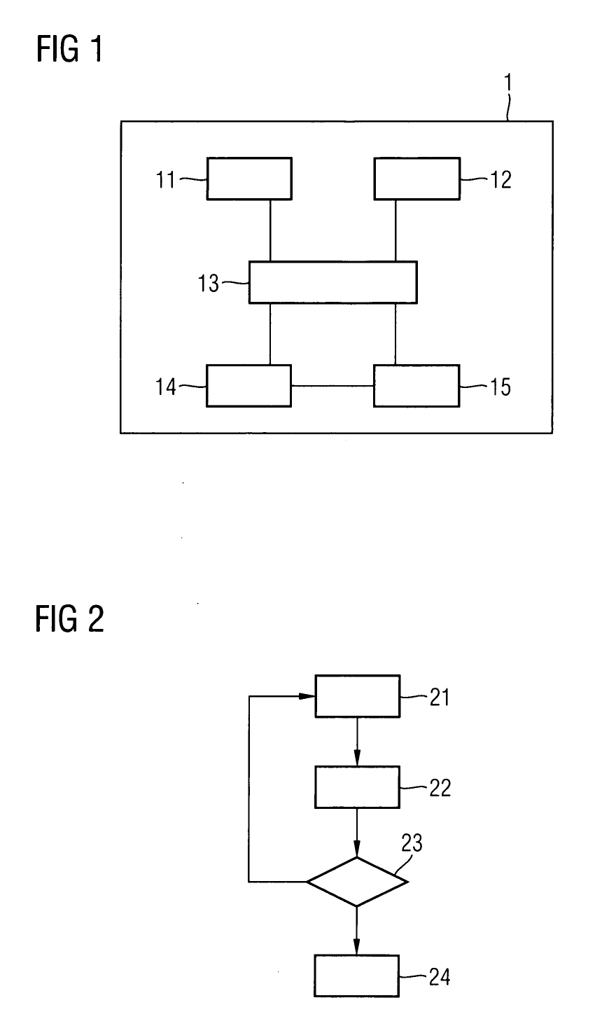

FIG. 1 shows a possible embodiment of an apparatus 1 which is configured for determine a structure of information, i.e. information data, exchanged between domains of organizations.

The apparatus 1 comprises a meta-schema database 11, which provides a meta-schema characterizing rules for generating or creating of schemas of domains within one or several organizations. Such a schema can concern information data, topics, workflows, processes, and/or objects processed and handled within a domain, wherein these information data, topics, workflows, processes, and/or objects can be exchanged with further domains of the same or different organizations. The meta-schema specifies requirements, rules, and/or constructs, which have to be met by each schema. A schema is generated by use of the meta-schema observes the requirements, rules, and/or constructs set out by the meta-schema. The meta-schema can specify in an abstract and generic requirement language rules, which have to be satisfied by a schema generated by use of this meta-schema.

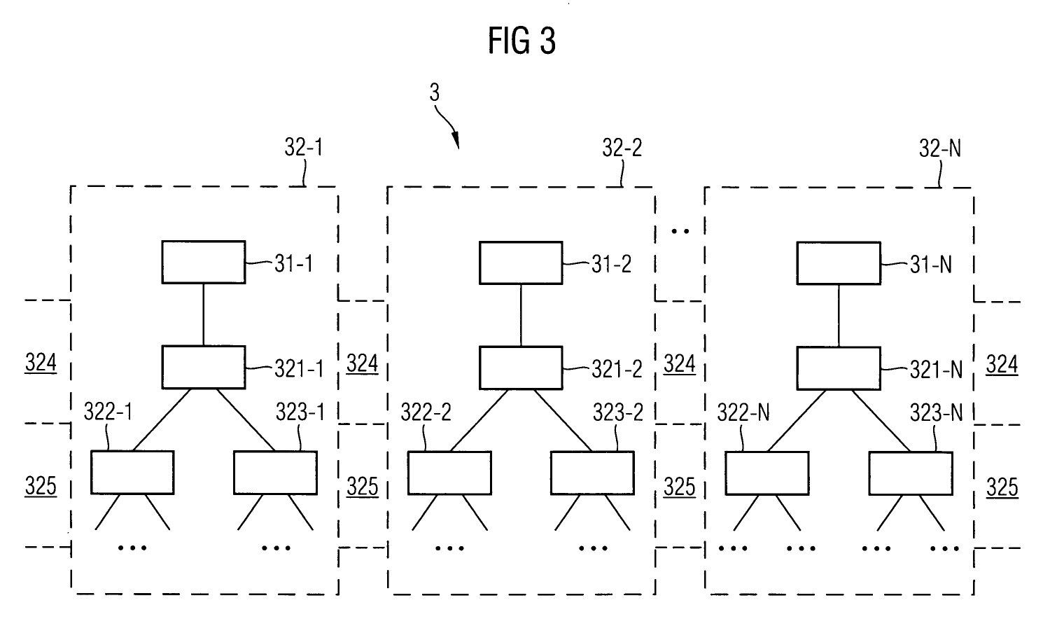

FIG. 3 shows in a diagram a schema 3 comprising at least one dimension and generated according to a predetermined meta-schema. The schema 3 shown in FIG. 3 has N dimensions.

In general, the meta-schema stored in the meta-module database 11 can specify that a schema 3 of selected domains of one or several organizations is structured as shown in FIG. 3 having N dimensions. According to the meta-schema provided by the meta-module database 11, each schema 3 comprises at least one dimension 32. Each dimension 32 describes and represents a certain kind or type of information, topics, workflows, processes, and/or objects of domains of one or several organizations. According to a rule of the meta-schema each dimension 32-i comprises a hierarchy of nodes having a root node 31-i as well as further nodes 321-i, 322-i, 323-i is assigned as shown in FIG. 3. Each hierarchy of nodes 321-i, 322-i, 323-i of a dimension 32-i is configured such that it specifies a corresponding dimension of the schema 3.

In particular, the hierarchy describes information, topics, workflows, processes, and/or objects sub-ordered to the main or generic information, topic, workflow, process, and/or object of root node. The nodes 321-i, 322-i, 323-i of the hierarchy are arranged in a hierarchical tree structure, wherein each node 322-i, 323-i of a lower or subordinated level 325 is associated to and specifies a node 321-i of an upper or superordinated level 324. In particular, an information, a topic, a workflow, a process, and/or an object represented by and assigned to a node 322-i, 323-i of a lower or subordinated level 325 specifies an information, a topic, a workflow, a process, and/or an object represented by the corresponding node 321-i of the upper or superordinated level 324. Furthermore, according to the rules of the meta-schema, the nodes 321-i, 322-i, 323-i of the hierarchy refer exclusively to one dimension 32-i of the schema 3. Thus, the information, topics, workflows, processes, and/or matters represented by the nodes 321-i, 322-i, 323-i of the hierarchy refer exclusively to the information, topic, workflow, process, and/or object represented by the dimension 32-i of the schema 3.

Thus, according to one rule of the meta-schema an orthogonallity of the different dimensions is predefined, i.e., each dimension 32-i is defined as being orthogonal to any other dimension 32-j of the schema 3. Due to the orthogonallity requirement or rule of the meta-schema, each dimension 32 in the schema 3 as shown in FIG. 3 can be considered as such, i.e., isolated from the other dimensions 32-j, if required. When considering FIG. 3, each node 321-i, 322-i, 323-i of the shown hierarchy refers to one single dimension 32-i only and can not be shared between several dimensions of the schema 3.

Thus, a strict structuring of information, topics, workflows, processes, and/or objects processed and handled within a domain is achieved, wherein each part or dimension of information, topics, workflows, processes, and/or object forms a hierarchical structure of corresponding information, topics, workflows, processes, and/or object of relevant domains and can be considered as such without other parts or dimensions of information, topics, workflows, processes, and/or objects of the relevant domains.

Here, it has to be pointed out that each information, topic, workflow, process, and/or object of relevant domains 32 is specified by a corresponding term used within the respective domain, i.e., this term specifies a certain information, topic, workflow, process, and/or object of the respective domain. Therefore, for sake of conciseness when considering and explaining the structure of the schema 3 shown in FIG. 3 the word “term” can be used as a superordinated term for “information, topic(s), workflow(s), process(es), and/or object(s) of a domain” in the following.

Moreover, according to a rule of the predetermined meta-schema stored in the database 11 shown in FIG. 1, a requirement of autology is set to the schema 3. Thus, each dimension 32 of terms in a domain is to be self-explanatory. All terms of a dimension 32-i represented by the nodes 321-i, 322-i, 323-i in the shown hierarchy are used to explain, characterize, and specify the respective dimension 32-i, i.e., the superordinated term represented by the dimension 32-i.

As a further rule a requirement of hierarchy is met by the generated schema 3 according to the meta-model, according to which an unambiguous hierarchical specification of terms used with regard to the term represented by the respective dimension 32-i has to be provided. Here, each term is represented by a node 322-i, 323-i, which does not belong to the top level 324 of the hierarchy but to a lower level 325, and is assigned unambiguously to its upper or superordinated term represented as an upper or superordinated node 321-i in the hierarchy.

Additionally, a requirement of modularization is met by the schema 3 generated according to the meta-model stored in the database 11 shown in FIG. 1. In particular, a modular decomposition of the hierarchy is provided, i.e. each of the subordinated terms represented by subordinated nodes 321, 322, 323, i.e., each subordinated node 321, 322, 323, in the respective hierarchy can be considered, analyzed, and processed individually. Further, each of the subordinated terms represented by subordinated nodes 321-i, 322-i, 323-i, and, thus, each of the subordinated nodes 321-i, 322-i, 323-i comprises its individual life cycle in the respective dimension 32-i.

According to the present embodiment, each information, topic, workflow, process, and/or object of a domain can be specified by a corresponding term, which in turn is represented as a node 321, 322, 323 in a hierarchy of the respective dimension 32-i having a root node 31-i and has its validity and its duration of validity, i.e., a life cycle, in a domain with regard to the respective dimension 32, i.e., with regard to the term and, thus, to the information or information data, topic, workflow, process, and/or object represented by the root node 31-i of the respective dimension 32-i.

Thus, for example, if a certain process of a domain (e.g., production process etc.) is referenced by a term, which is represented as a root node 31 in the schema 3, the sub-processes of this process and the specific information, topics, workflows, processes, and/or objects of this process are then represented as nodes 321, 322, 323 in the hierarchy of the dimension 32, wherein each of the sub-processes of this process and the specific information, topics, workflows, processes, and/or matters of this process are referred to or specified by a corresponding term in the corresponding node 321, 322, 323. Each of these sub-processes and specific information, topics, workflows, processes, and/or matters exists in the certain process for a certain period of time and, thus, has its predetermined validity and predetermined duration of validity, i.e., a life cycle, with regard to the certain process represented as the dimension 32 in the schema 3. For example, one sub-process represented as a node 321, 322, 323 is performed at the beginning of the process represented by a dimension or a root node 31, another sub-process, in turn, represented as a node 321, 322, 323 is performed at the end of the process.

In the schema 3 as shown in FIG. 3, each node 321-i, 322-i, 323-i sub-ordered within a hierarchy to a root node 31-i comprises its life-cycle with regard to or within the respective dimension 32-i.

By the modular arrangement of the nodes 321, 322, 323, the requirement of modularity of the meta-schema is met and a flexible and efficient handling and processing of data represented by use of the schema 3 is possible. This handling and processing can be adapted to actual circumstances of domains of one or several organizations.

When using the requirements set to the schema 3 by the meta-schema according to an embodiment of the present invention, as explained above, the following characteristics can be derived for each dimension 32 of the schema 3:

Each dimension 32 represents an information, topic, workflow, process, and/or matter specified by a term in domains, for which the schema 3 is provided, wherein this information, topic, workflow, process, and/or object specified by the term is orthogonal to further information, topics, workflows, processes, and/or objects (each specified by a term and represented by a node). Thus, an isolated consideration or view of topics of the respective domains is possible.

It is not admissible, that one dimension 32-i dominates another dimension 32-j in the schema 3. The view with regard to information, topics, workflows, processes, and/or objects specified by terms and/or the use of the information, topics, workflows, processes, and/or objects specified by terms in the relevant domains are the only criteria for a possible dominance or for an order of dimensions.

If possible, a small number of dimensions 32 is defined, since with an increasing number of dimensions 32 the probability of infringing of the orthogonallity rule or requirement of the meta-schema increases.

Each dimension 32 describes or specifies itself (authology rule or requirement) by terms (and, thus, information, topics, workflows, processes, and/or objects specified by the terms) represented and ordered hierarchically by nodes 321, 322, 323 of the node hierarchy of a dimension 32.

Each dimension 32 comprises or is associated to hierarchically fragmented nodes 321, 322, 323, wherein the dimension 32 comprises a root node 31 of the node hierarchy, i.e., of the hierarchically fragmented nodes 321, 322, 323, wherein the term of the dimension can be assigned to the root node 31.

Each node 321, 322, 323 of a hierarchy is assigned only to a single dimension 32 of the schema 3.

Each node 321, 322, 323 can be structured in a subordinated way, wherein each subordinated node 322, 323 of a subordinated or lower level 325 provides information with regard to one superordinated or upper level 324, 325 only (i.e., with regard to only one superordinated or upper node 321, 322, 323) and wherein a superordinated level 324, 325 specifies or describes superordinated features or characteristics of the subordinated levels 325.

Nodes of the same level of a node hierarchy as shown in FIG. 3 represent comparable nodes. When considering FIG. 3, nodes 322 and 323 represent such comparable nodes forming nodes of level 325, i.e. they are comparable with regard to features and characteristics specified by the corresponding level 325.

The full and complete concept or meaning of the term characterized by a node 321, 322, 323 is derived by considering the path leading from the root node 31 to the corresponding node 321, 322, 323 within the hierarchy.

Each node 321, 322, 323 comprises at least one of the following features or specifications of the node 321, 322, 323: denotation; description; synonyms; and structure information specifying the subordinated levels 324, 325 and, thus, the nodes 321, 322, 323 of the subordinated levels 324, 325.

Further, when returning to FIG. 1, the apparatus 1 can comprise an ontology module 12 being configured to provide an ontology specifying concepts and relationships of one or several domains, for which a schema 3 of terms, information, topics, workflows, processes, and objects used or provided within the respective domains is generated.

Furthermore, the apparatus 1 comprises a schema generating module 13, which is configured to determine or to generate a schema for relevant domains by use of the meta-schema provided by the meta-schema database 11. When generating or determining a schema 3 of relevant or selected domains, a classification of terms, topics, and matters used within the domains is performed by utilization of the meta-schema and possibly the ontology.

The schema generating module 13 is configured to generate a schema 3, which follows and complies with rules and characteristics, i.e., general requirements specified by the meta-schema and which covers the relevant domains in an optimal way. Thus, the schema 3 specifies relevant and important information, topics, workflows, processes, and matters of the relevant domains in a clearly structured way by considering and/or involving actual circumstances in the respective domains. In particular, periodic changes in the involved domains are taken into account by the schemas as each node of the schema is aware of its life scale.

To arrive at an optimal specification of relevant domains by a schema 3, the determining or generating module 13 can be configured to generate the schema 3 in an iterative way. Here, to each schema 3 provided as a result of the iterative generation a version of the schema 3 can be assigned. Thus, a versioning of determined schemas 3 can be performed. By use of versions established and generated by the schema generating module 13, it becomes possible to verify and to improve the schema 3 at any time. Further, if changes in one of the relevant domains 32 occur, these changes can be incorporated into the respective schema 3 in a fast and effective way, wherein a new version of the schema 3 is established and determined by the schema generating module 13.

In the following, two possible phases of determining or generating of a schema 3 are presented by way of example. Here, the schema generating module 13 is configured to perform these two phases.

In a first phase, an identification of dimensions 32 for specification of information, topics, workflows, processes, and/or objects of relevant domains is performed. In particular, in the first phase orthogonal dimensions 32 are searched, which are able or suited to specify or characterize the relevant domains and which satisfy the requirements of the meta-schema. The search for orthogonal dimensions 32 can e.g. be performed by evaluating or processing replies to questions beginning with one of the following interrogative pronouns: who, what, when, whereby, how, where, why etc. By processing replies to such questions, an exact orientation with regard to determining of dimensions 32 for relevant domains is provided. Moreover, for the further operation, it can be helpful to perform a documentation of the detection and generation of the dimensions 32.

After detection or generation of a dimension 32 it can be checked, whether the information, topics, workflows, processes, and/or objects comprised in and covered by the respective dimension 32 are comprised in or covered by other dimensions 32 of the schema 3 or whether these information, topics, workflows, processes, and/or matters of the dimension 32 have functional dependencies with regard to other information, topics, workflows, processes, and/or objects of other dimensions 32 of the same schema 3.

In a second phase, terms of a dimension 32 specifying the information, topics, workflows, processes, and/or objects of the dimension 32 are determined or identified. Here, the terms represent such terms, which are represented by nodes 321, 322, 323 in the node hierarchy of the respective dimension 32. Here, when generating the hierarchy of terms or nodes 321, 322, 323 respectively, a hierarchical structure of the terms, i.e., nodes 321, 322, 323 in the hierarchy is to be maintained. If no strict hierarchy is possible with the determined terms, i.e., nodes 321, 322, 323, either a restart of the first phase of detecting of dimensions 32 or a restart of the second phase of detecting of terms or nodes 321, 322, 323 respectively has to be performed.

Further, according to the present embodiment shown in FIG. 1, the apparatus 1 can comprise a data collecting module 14, which is configured to collect data by use of the schema 3 provided by the schema generating module 13. Here, data is collected by use of the schema 3, i.e., by following or complying with the rules of the meta-schema.

Additionally, according to the embodiment shown in FIG. 1, the apparatus 1 can comprise an analysis module 15, which is configured to perform analysis of data collected by the data collecting module 14 in line with the schema 3 determined by the schema generating module 13. Here, the analysis module 15 can be configured to utilize analysis methods, which concern, for example, data search, data querying, data mining, data mapping etc.

FIG. 2 shows a flowchart of a method for detecting of a structure of information exchanged between domains of one or several organizations according to an embodiment of the present invention.

Here, the method comprises a first step 21 configured for determining of a schema 3 of relevant domains of one or several organizations by use of a meta-schema as described above with regard to module 13 of FIG. 1.

Further, the method comprises a second step 22 configured for evaluating of the schema 3 determined in step 21. In a third step 23, it is checked whether several requirements set by the meta-schema to the schema 3 are satisfied by the determined schema 3. If this is not the case, a re-determining of the schema 3 is performed (e.g., as explained above with regard to the two phases of schema determining module 13 of FIG. 1), wherein the already determined schema 3 is stored as a schema of a previous version and wherein a further version is established with regard to or for the schema determined with the re-determining process. Here, the re-determining is represented by a loop back to the first step 21. If the determined schema 3 satisfies the requirements of the meta-schema, the determined schema 3 is provided for further use in a fourth step 24. Here, for example, domain relevant data can be collected in line with the determined schema 3 or analysis of the collected data can be performed.

Here, it has to be noted, that the information, topics, workflows, processes, and/or objects described by dimensions 32 of a schema 3 and the information, topics, workflows, processes, and/or objects described by nodes 321, 322, 323 of several levels 324, 325 in a hierarchy of a dimension 32 of a schema 3 can have their own life cycles, as explained above. Therefore, it is also possible to change or amend a schema 3 which has already been generated. When changes or amendments of an already generated schema 3 are performed, steps 21, 22, 23, and 24 shown in FIG. 2 can be performed in a similar way as described above, wherein the first step 21 is performed as the re-determining step. Further, with each new determining of the schema 3 a new version of the schema 3 is generated, wherein the schema 3 used until the anew determining of the schema is stored or saved as a previous version of the schema 3, e.g., in a data storing module configured for storing of data. Such a data storing module can be, for example a memory, database etc. Thus, with each amendment of the schema 3 a versioning of the schema 3 is performed.

In following, determining of a schema 3 for relevant domains is described in more detail. According to the present embodiment, the structure of a consulting company is considered, wherein it is desired to optimize processes with regard to consultation ranges.

Here, at first, dimensions 32 of the consultation area or domain are determined. For example, the three following dimensions, i.e., the following general information, topics, workflows, processes, and/or objects are determined for a consultation domain:
Type of results (first dimension X);
Process phase (second dimension Y);
Skills (third dimension Z)
   More than three dimensions 32 are possible, i.e. four, five or more dimensions.

Then, after the dimensions 32 have been detected the corresponding hierarchical arrangements of the dimensions, i.e., information, topics, workflows, processes, and/or objects specifying the dimensions identified above are determined and specified.

For the first dimension “Type of results” (dimension 32-X), the following hierarchy of terms (specifying information, topics, workflows, processes, and/or objects of this dimension) can be derived by use of an ontology representing concepts and relationships of the consultation area:
Report

Market analysis

Portfolio analysis

Evaluation of tools
Development

Prototype/showcase

Completed (partial) functionality

In particular, the dimension “Type of results” specifies several results which can be achieved during consultations.

For the second dimension “Process phase” (dimension 32-Y), the following hierarchy of terms (specifying information, topics, workflows, processes, and/or objects of this dimension) by use of an ontology can be derived:
Planning

Product management

Management of requirements

Architecture
Development

Development of projects

Performing of development tasks

With the second dimension “Process phase” a specification of such phases is provided, in which a customer can be during consultation. The dimension “Process phase” can be considered independently from the dimension “Type of results” as in all phases specified by the dimension “Process phase” different projects of consultation are performed. Further, it has to be noted that the use of the term “Development” in the dimension “Type of results” and in the dimension “Process phase” is allowable according to the present embodiment as several meanings are connected to the term “Development” within the two dimensions.

For the third dimension “Skills” (dimension 32-Z), the following hierarchy of terms (specifying information, topics, workflows, processes, and/or objects of this dimension) by use of the ontology is derived:
Knowledge of Domains

Health care

Power supply

Industry
Programming

C++

Java

VBA
Tools

Eclipse

Office tools

Tools for project management

Tools for requirements management

In particular, the third dimension “Skills” describes skills and methods of persons providing the consultation.

The terms of the three dimensions (X, Y, Z) are detected such that they describe only the corresponding dimension 32-i (i.e. specify information, topics, workflows, processes, and/or objects of the corresponding dimension), to which they are assigned. In this way, the requirement of orthogonality set out by the meta-schema as explained above is met by the schema 3.

After generating of the schema 3 as indicated above, collecting of data by use of the determined schema 3 can be performed. According to the present embodiment, data is collected with regard to the following three projects:
P1: Support of product management in area of computer tomographs;
P2: Comparison of self-developed control systems for power supply; and
P3: Defining of an architecture of a next generation of an automatization system.

For verification of data, expert databases of corresponding domains of corresponding companies can provide the necessary input data.

The following table shows a schema 3 generated according to the rules of the meta-schema. In the given example, sales achieved with regard to determined dimensions referred to as X, Y, Z and with regard to corresponding hierarchies of the dimensions X, Y, Z are presented as data collected with regard to three projects P1 to P3, wherein the domains “Finance” and “Human Resource” (referred to as “HR” in following) of a consulting company are considered:

| | | Domain | | | | |
|---|---|---|---|---|---|---|
| | | | | | HR | |
| Hier- | | Finance | | | | Tar- |
| archy | Dimension or Node | P1 | P2 | P3 | As-is | get |
| X | Type of results | 20.000 [symbol] | 30.000 [symbol] | 40.000 [symbol] | | 100% |
| X1 | Report | 20.000 [symbol] | 30.000 [symbol] | 10.000 [symbol] | | ??? |
| X1.1 | Market analysis | 10.000 [symbol] | 5.000 [symbol] | — [symbol] | | ??? |
| X1.2 | Portfolio analysis | 5.000 [symbol] | 15.000 [symbol] | 10.000 [symbol] | | ??? |
| X1.3 | Evaluation of tools | 5.000 [symbol] | 10.000 [symbol] | — [symbol] | | ??? |
| X2 | Development | — [symbol] | — [symbol] | 30.000 [symbol] | | ??? |
| X2.1 | Prototype/showcase | — [symbol] | — [symbol] | 5.000 [symbol] | | ??? |
| X2.2 | Completed (partial) | — [symbol] | — [symbol] | 25.000 [symbol] | | ??? |
| | functionality | | | | | |
| Y | Process phase | 20.000 [symbol] | 30.000 [symbol] | 40.000 [symbol] | | 100% |
| Y1 | Planning | 20.000 [symbol] | — [symbol] | 20.000 [symbol] | | ??? |
| Y1.1 | Product | 5.000 [symbol] | — [symbol] | — [symbol] | | ??? |
| | management | | | | | |
| Y1.2 | Management of | 10.000 [symbol] | — [symbol] | — [symbol] | | ??? |
| | requirements | | | | | |
| Y1.3 | Architecture | 5.000 [symbol] | — [symbol] | 20.000 [symbol] | | ??? |
| Y2 | Development | — [symbol] | 30.000 [symbol] | 20.000 [symbol] | | ??? |
| Y2.1 | Development of | — | 30.000 [symbol] | — [symbol] | | ??? |
| | projects | | | | | |
| Y2.2 | Performing of | — [symbol] | — [symbol] | 20.000 [symbol] | | ??? |
| | development tasks | | | | | |
| Z | Skills | 20.000 [symbol] | 30.000 [symbol] | 40.000 [symbol] | 100% | 100% |
| Z1 | Knowledge of | 10.000 [symbol] | 10.000 [symbol] | 10.000 [symbol] | 30% | ??? |
| | domains | | | | | |
| Z1.1 | Healthcare | 10.000 [symbol] | — [symbol] | — [symbol] | 20% | ??? |
| Z1.2 | Power supply | — [symbol] | 10.000 [symbol] | — [symbol] | 40% | ??? |
| Z1.3 | Industry | — [symbol] | — [symbol] | 10.000 [symbol] | 40% | ??? |
| Z2 | Programming | — [symbol] | 15.000 [symbol] | 10.000 [symbol] | 30% | ??? |
| Z2.1 | C++ | — [symbol] | 5.000 [symbol] | — [symbol] | 20% | ??? |
| Z2.2 | Java | — [symbol] | 10.000 [symbol] | 10.000 [symbol] | 40% | ??? |
| Z2.3 | VBA | — [symbol] | — [symbol] | — [symbol] | 40% | ??? |
| Z3 | Tools | 10.000 [symbol] | 5.000 [symbol] | 20.000 [symbol] | 40% | ??? |
| Z3.1 | Eclipse | — [symbol] | — [symbol] | 20.000 [symbol] | 20% | ??? |
| Z3.2 | Office Tools | — [symbol] | 5.000 [symbol] | — [symbol] | 40% | ??? |
| Z3.3 | Tools for project | — [symbol] | — [symbol] | — [symbol] | 10% | ??? |
| | management | | | | | |
| Z3.4 | Tools for | 10.000 [symbol] | — [symbol] | — [symbol] | 30% | ??? |
| | requirements | | | | | |
| | management | | | | | |

Here, entries of the shown table schema 3 comprising the string “???” indicate that the values of the corresponding data fields are not determined yet. For the domain “HR” it is indicated how well knowledge of human resources working within the projects P1 to P3 covers the corresponding topics of the corresponding dimensions, wherein for the domain “HR” the coverage of the knowledge is provided as it is currently (“As-is”) and as it is targeted (“Target”). The degree of how far the knowledge of the human resources covers a corresponding topic is indicated by a percentage value and can be determined by use of information concerning the education of the human resources HR involved in the projects P1 to P3 with regard to the corresponding topics.

On the basis of the collected data which can be read from an expert database an analysis of this data can be performed. According to the present embodiment, an application of Business Intelligence is used for analysis purpose. In particular, the analysis is performed with regard to the domain “Finance”. According to the present embodiment, the collected data is represented by use of a cube, wherein the dimensions X, Y, Z. (Type of results, Process phase, and Skills) represent edges of the cube and wherein the cells of the cube represent the data collected in line with the schema of the present embodiment.

The following table shows apportioning of sales achieved in the project P1 with regard to the third dimension Z (Skills), wherein the apportioning is provided in percentage. Thus, entries of the cells represent a sale achieved with regard to the corresponding topic within the scope of project P1 in percentage.

| Z | X | X1 | X1.1 | X1.2 | X1.3 | X2 | X2.1 | X2.2 |
|---|---|---|---|---|---|---|---|---|
| Y | 100% | 100% | 50% | 25% | 25 | 0 | 0 | 0 |
| Y1 | 100 | 100 | 50 | 25 | 25 | 0 | 0 | 0 |
| Y1.1 | 25 | 25 | 13 | 6 | 6 | 0 | 0 | 0 |
| Y1.2 | 50 | 50 | 25 | 13 | 13 | 0 | 0 | 0 |
| Y1.3 | 25 | 25 | 13 | 6 | 6 | 0 | 0 | 0 |
| Y2 | 0 | 0 | 0 | 0 | 0 | 0 | 0 | 0 |
| Y2.1 | 0 | 0 | 0 | 0 | 0 | 0 | 0 | 0 |
| Y2.2 | 0 | 0 | 0 | 0 | 0 | 0 | 0 | 0 |

Here, many different ways of analysis of the collected data structured by use of the determined schema are possible. The table provided above shows just one example of a plurality of possible analysis results.

Thus, for example, by common use of the dimension “Skills” for both domains “Finance” and “HR” an efficient analysis with regard to the collected data can be performed. For example, the organizing or re-organizing of the domain “HR” in the consulting company can be performed with regard to sales achieved and with regard to education and skills required actually for performing of projects. Further, it becomes possible to determine a more sale oriented information concerning importance of certain skills with regard to certain tasks or topics which is sale oriented.

For a long term analysis several domains can be considered and it becomes possible to meet more stable and more reasoned decisions. Moreover, planning, strategic discussions, management etc. within an organization can be performed in a clear and well structured way.

Further, the determined schema 3 does not form a fixed unadaptable schema. If further developments or if further projects P with regard to further areas begin in the consulting company, an adaptation of the determined schema 3 is always possible by use of the method according to the present invention. Here, the schema 3 used previously can be marked and stored as an earlier version, wherein the adapted schema is marked and stored as the current version. Thus, a versioning of schemas 3 is enabled.

At least one embodiment of the present invention can be used, for example, in areas related to management and control of an organization and provides transparent, structured, multi-facetted, and differentiated views to concepts, matters, and relationships of the organization.

Moreover, an effective and efficient evolution of a schema 3 determined with regard to at least one domain of one or several organizations is enabled by use of which evaluating of several management, organization etc. strategies becomes possible. In particular, by possibility of versioning of several development stages of a schema 3 according to the present invention, a comparability of diverse steps or phases of development of the schema is enabled.

While embodiments and applications of this invention have been shown and described above, it should be apparent to those skilled in the art, that many more modifications (than mentioned above) are possible without departing from the inventive concept described herein. The invention, therefore, is not restricted except in the spirit of the appending claims. Therefore, it is intended that the foregoing detailed description should be regarded as illustrative rather than limiting.

List of References
1 apparatus
11 a meta-schema module
12 an ontology module
13 a schema generating module
14 a data collecting module
15 an analysis module
21 determining of a schema
22 evaluating of a schema
23 checking step
24 providing of a schema (for use)
3 schema
31 root node
32 dimension
321 a node
322 a node
323 a node
324 a layer of a hierarchy of nodes
325 a layer of a hierarchy of nodes

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for detecting and evolving of a structure for storage, analysis and exchange of information data between domains and organizations comprising:
determining a schema of all relevant domains of the organizations on the basis of a meta-schema.

2. The method according to claim 1, wherein said meta-schema comprises a set of rules for generating a schema having at least one dimension.

3. The method according to claim 2, wherein said rules of said meta-schema are formed by
an orthogonality rule that all dimensions of said determined schema are orthogonal to each other;
a hierarchy rule that each dimension of said determined schema comprises subterms assigned to nodes of a tree-structured hierarchy of nodes having a root node to which a term is assigned forming said dimensions;
an autology rule that each dimension is self-explanatory by the subterms assigned to the nodes of the tree-structured hierarchy of nodes of said dimension; and
a modularity rule that each hierarchy of nodes can be decomposed into submodules of nodes.

4. The method according to claim 3, wherein each of the nodes of said hierarchies of nodes comprises at least one of the following:
a description of the respective node;
a denotation of the respective node;
a list of synonyms for said denotation of the respective node; and
a structure information specifying the nodes placed in levels below the level in the related hierarchy, at which the respective node is provided.

5. The method according to claim 1, wherein said method further comprises an evaluating of the determined schema of said domains.

6. The method according to claim 5, wherein said method comprises a re-determining or evolution of said schema of said domains if an evaluation result indicates that further aspects of said domains have to be covered by said schema of said domains.

7. The method according to claim 1, wherein said method is performed by a computer program executed by a processor.

8. A data carrier which stores a computer program comprising instructions for performing the method according to claim 1.

9. An apparatus, said apparatus being configured for determining of a structure of information exchanged between domains of organizations, said apparatus comprising:
a meta-schema database to provide a meta-schema comprising a set of rules for generating a schema; and
a schema generating module, said schema generating module being configured to generate said schema for said domains of said organizations on the basis of said meta-schema provided by said meta-schema database.

10. The apparatus according to claim 9 further comprising a schema evolution module, said schema evolution module being configured to perform an evolution for said schema.

11. The apparatus according to claim 9, wherein said rules of said meta-schema comprises:
an orthogonality rule that all dimensions of said determined schema are orthogonal to each other;
a hierarchy rule that each dimension of said determined schema comprises subterms assigned to nodes of a tree-structured hierarchy of nodes having a term forming said dimensions as a root node;
an autology rule that each dimension is self-explanatory by the subterms assigned to the nodes of the tree-structured hierarchy of nodes of said dimension; and
a modularity rule that each hierarchy of nodes can be decomposed into submodules of nodes.

12. The apparatus according to claim 9, wherein said schema generating module comprises a data processing unit.

13. An apparatus for increasing a transparency of information data exchanged between processes of different domains and organizations comprising a data processing unit which operates on the basis of a stored common schema provided according to validation and generation rules of a meta-schema.

14. The apparatus according to claim 13, wherein said meta-schema is stored in a database.

15. The apparatus according to claim 13, wherein said schema comprises orthogonal term dimensions each having a tree-structured hierarchy of subterms.

16. A computer readable medium including program segments for, when executed on a computer device, causing the computer device to implement the method of claim 1.
